(19) United States
(12) Patent Application Publication
(10) Pub. No.: US 2025/0259066 A1
(43) Pub. Date: Aug. 14, 2025

(54) DIGITAL TWIN SYMBIOTIC TRAINING

(71) Applicant: INTERNATIONAL BUSINESS MACHINES CORPORATION, Armonk, NY (US)

(72) Inventors: Zhong Fang Yuan, Xi'an (CN); Tong Liu, Xi'an (CN); Han Qiao Yu, Shaanxi Province (CN); Kun Yan Yin, Ningbo (CN)

(21) Appl. No.: 18/436,419

(22) Filed: Feb. 8, 2024

(51) Int. Cl. G06N 3/0895

(52) U.S. Cl. CPC G06N 3/0895

(57) ABSTRACT

Methods and systems for training a digital twin include submitting a hardware prompt to a language model that characterizes hardware of an original system. A software prompt is submitted to the language model that characterizes software of the original system. A discriminant model is trained to distinguish between outputs of the original system and outputs of the language model. The language model is tuned to act as a digital twin of the original system based on an output of the discriminant model, an output of the language model, and an output of the original system.

### BACKGROUND

The present invention generally relates to system simulation and to digital twins.

A digital twin is a software-based representation of an object or system. In cases of a physical object, the digital twin may include a digital representation of the physical properties of the object and the physics of the object's environment. The digital twin of an original object or system is designed such that inputs to the digital twin evoke a response that matches the response that the original object or system would perform under the same inputs.

In the context of computer systems, the system that is being represented by the digital twin may include software components and hardware components.

### SUMMARY

A method for training a digital twin includes submitting a hardware prompt to a language model that characterizes hardware of an original system. A software prompt is submitted to the language model that characterizes software of the original system. A discriminant model is trained to distinguish between outputs of the original system and outputs of the language model. The language model is tuned to act as a digital twin of the original system based on an output of the discriminant model, an output of the language model, and an output of the original system.

A system for training a digital twin includes a hardware processor and a memory that stores a computer program. When executed by the hardware processor, the computer program causes the hardware processor to submit a hardware prompt to a language model that characterizes hardware of an original system, to submit a software prompt to the language model that characterizes software of the original system, to train a discriminant model to distinguish between outputs of the original system and outputs of the language model, and to tune the language model to act as a digital twin of the original system based on an output of the discriminant model, an output of the language model, and an output of the original system.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram illustrating symbiotic training of a digital twin of an original system, in accordance with an embodiment of the present invention;

FIG. 2 is a block diagram illustrating components of symbiotic training of a digital twin, in accordance with an embodiment of the present invention;

FIG. 3 is a block/flow diagram of a method for generating a hardware configuration for a digital twin, in accordance with an embodiment of the present invention;

FIG. 4 is a block/flow diagram of a method for generating a software configuration for a digital twin, in accordance with an embodiment of the present invention;

FIG. 5 is a block/flow diagram of a method for training a discriminant model to classify outputs of a digital twin, in accordance with an embodiment of the present invention;

FIG. 6 is a block/flow diagram of a method for online tuning of a digital twin and a discriminant method during symbiotic training, in accordance with an embodiment of the present invention;

FIG. 7 is a block/flow diagram for training and using a digital twin to make modifications to an original system, in accordance with an embodiment of the present invention;

FIG. 8 is a block diagram of a computing environment that can train and use a digital twin, in accordance with an embodiment of the present invention;

FIG. 9 is a diagram illustrating an exemplary neural network architecture that can be used to implement a discriminant model, in accordance with an embodiment of the present invention; and

FIG. 10 is a diagram illustrating an exemplary deep neural network architecture that can be used to implement a discriminant model, in accordance with an embodiment of the present invention.

### DETAILED DESCRIPTION

Creating a digital twin can be a time consuming and complex process, which may include a large amount of data acquisition and processing. Additionally, after the original system has been modeled, the result may be a static model which may be difficult to adapt to changes in a real-time environment. Instead of creating a digital twin through explicit modeling of the original system, large language models may be used to predict the behavior of the original system in response to new inputs.

Large language models (LLMs) are a category of foundation models (machine learning models) trained on immense amounts of data making them capable of understanding and generating natural language and other types of content to perform a wide range of tasks. LLMs are an implementation of artificial intelligence and, more particularly, generative artificial intelligence. LLMs have natural language understanding (NLU) and natural language processing (NLP) capabilities. Machine learning, machine learning models, algorithms, neural networks and transformer models provide architecture for LLMs. LLMs are a class of foundation models, which are trained on enormous amounts of data to provide the foundational capabilities needed to drive multiple use cases and applications, as well as resolve a multitude of tasks. LLMs are accessible through interfaces and provide information and/or perform tasks in response to receiving a prompt in natural language. LLMs are designed to understand and generate text like a human, in addition to other forms of content, based on the vast amount of data used to train them. Some features that LLMs have in some embodiments include the ability to infer from context, to generate coherent and contextually relevant responses, to translate text to different human languages, to summarize text, to answer questions (general conversation and FAQs), and to assist in creative writing and/or code generation tasks. The LLMs in some embodiments include billions of parameters that enable them to capture intricate patterns in language and perform a wide array of language-related tasks. LLMs are implementable in various fields, from chatbots and virtual assistants to content generation, research assistance and language translation.

LLMs operate by leveraging deep learning techniques and vast amounts of textual data. These models are in many embodiments based on a transformer architecture, like the generative pre-trained transformer, which handles sequential data like text input. LLMs in many embodiments include multiple layers of neural networks, each with parameters that can be fine-tuned during training, which are enhanced further by a numerous layer known as the attention mechanism, which dials in on specific parts of data sets. During the training process, these models learn to predict the next word in a sentence based on the context provided by the preceding words. The model does this through attributing a probability score to the recurrence of words that have been tokenized-broken down into smaller sequences of characters. These tokens are then transformed into embeddings, which are numeric representations of this context.

To ensure accuracy, this process involves training the LLM on a massive corpora of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they've acquired. The result is coherent and contextually relevant language generation that can be implemented for NLU and content generation tasks. Model performance can also be increased through prompt engineering, prompt-tuning, fine-tuning and other tactics like reinforcement learning with human feedback (RLHF).

For example, large language models can simulate the overall structure and composition of a computer server. The model may generate information about server-related technical terms, network topology, hardware components, and operating system architecture. This enables the model to represent a virtual server environment with a realistic structure. Such large language models can receive commands input by users and can furthermore process the user's intent. This allows the user to interact with the digital twin by providing instructions to the large language model.

In response to receiving such commands, the large language model may simulate the execution of commands, management of files and directories, configuration of network settings, and any other appropriate action that the original system might take. The large language model may then generate and output information related to the execution results. For example, it may generate the output of commands, error messages, and status reports to provide feedback to the user about the operation of the original system.

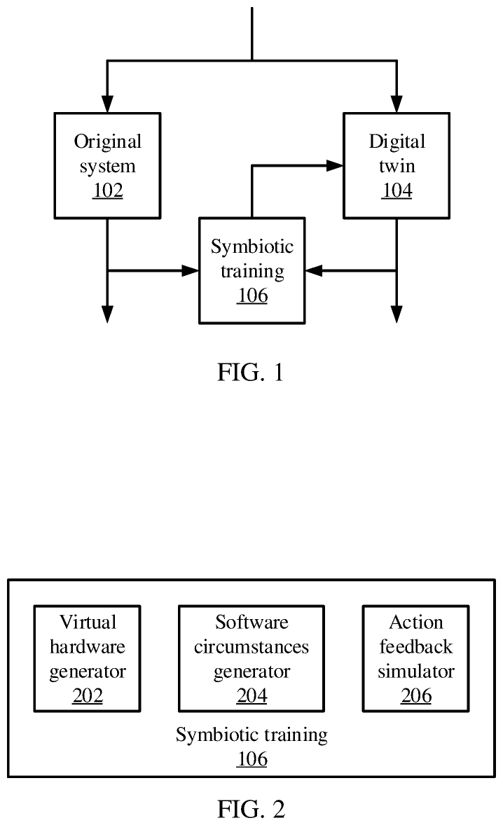

Referring now to FIG. 1, an exemplary training overview for a digital twin is shown. In this example, an original system 102 is implemented using a combination of original software and original hardware. A digital twin 104 is implemented using a large language model, which has been fed information relating to the original system 102. Training of the digital twin 104 may be performed by symbiotic training 106, with inputs being fed to both the original system 102 and the digital twin 104. Various examples of these inputs are described below with respect to FIGS. 2-7. The outputs of both the original system 102 and the digital twin 104 are processed and compared by the symbiotic training 106 to improve the digital twin 104.

By providing real-time updates about the original system 102 to the digital twin 104, the digital twin 104 is kept up-to-date with changes in the behavior of the original system 102. The real-time updating is referred to as running both the original system 102 and the digital twin 104 in parallel. This real-time feedback saves significant time in maintaining the digital twin 104 and obviates the need for periodic retraining. The symbiotic training 106 also helps to quickly identify novel inputs and their responses, creating a more robust digital twin 104 that can accurately respond to a wide variety of inputs, even those which occur rarely.

The digital twin 104 is a virtual model designed to accurately reflect a physical object. Information about the state and operation of the object is then relayed to a processing system and applied to the digital copy. Once informed with such data, the digital twin 104 can be used to run simulations, study performance issues and generate possible improvements, all with the goal of generating valuable insights—which can then be applied back to the original system 102.

Although simulations and digital twins both utilize digital models to replicate a system's various processes, a digital twin is actually a virtual environment, which makes it considerably richer for study. The difference between a digital twin and a simulation may be seen as a matter of scale: While a simulation typically studies one particular process, a digital twin can itself run any number of useful simulations in order to study multiple processes.

By having better and constantly updated data related to a wide range of areas, combined with the added computing power that potentially accompanies a virtual environment relative to the original system 102, the digital twin 104 can be used to study more issues from far more vantage points than standard simulations can—with greater ultimate potential to improve the original system 102.

In exemplary embodiments, the original system 102 is implemented on hardware that has few computing resources, or has limited input/output capabilities. By creating the digital twin 104, which is implemented in software with arbitrary amounts of computing power, testing may be performed at a speed and cost efficiency that may not be possible running on the original hardware. In exemplary embodiments, the original system 102 may run on custom or legacy hardware that is no longer commercially available. In such instances, creating the digital twin 104 makes it possible to replicate functionality of the original system 102 without having to reverse engineer it or take it out of service.

Referring now to FIG. 2, additional detail on the symbiotic training 106 is shown. The digital twin 104 is trained in some embodiments using a virtual hardware generator 202, a software circumstances generator 204, and an action feedback simulator 206. The virtual hardware generator 202 generates hardware specification prompts for the large language model of the digital twin 104, based on the hardware of the original system 102. The software circumstances generator 204 retrieves software, dependency, and environment information from the original system 102 and uses the retrieved information to generate software specification prompts for the digital twin 104. The action feedback simulator 206 handles outputs from the original system 102 and the digital twin 104 and provides feedback to the digital twin 104 refine its configuration.

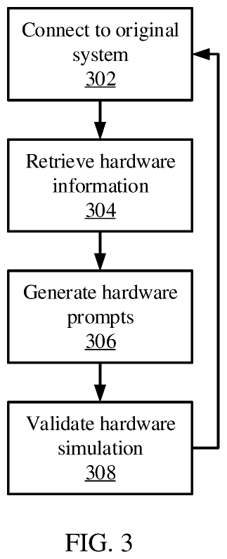

Referring now to FIG. 3, detail on the operation of the virtual hardware generator 202 is shown. Block 302 connects to the original system 102. This connection may be by any appropriate wired or wireless communications medium and protocol. For example, block 302 may use the secure shell (“ssh”) utility to connect to the original system over an IP connection. With appropriate credentials, the symbiotic training 106 can thereby access configuration and status information of the original system 102.

Block 304 fetches hardware information from the original system 102. This may include the execution of one or more predetermined scripts over the connection to the original system, for example accessing hardware information such as processor type, speed, and utilization; memory type, speed, and size; network interface type and speed; peripheral type; and any other pertinent features of the physical hardware of the original system 102.

Block 306 generates hardware prompts from the retrieved hardware information. This may use natural language processing to generate a text prompt, such as, “Simulate a Linux system with the following hardware: Eight processors; 64 GB of memory, and a 100 GB storage drive.” Block 306 may submit these prompts to the large language model of the digital twin 104 to cause the digital twin 104 to imitate the specified hardware. Submitting the prompt may include entering the prompt into an interface of the digital twin's language model, for example as natural language text. The submission may be made by the entity that runs and trains the digital twin 104, for example receiving information about the original system 102 and entering that information as a prompt, in the event that the original system 102 is not in the possession of the same entity that controls the digital twin 104. In at least some embodiments the generation of the text prompt and submission of same to the large language model is performed in an automated manner via the code 819 shown in FIG. 8.

Block 308 may then validate the hardware configuration by sending additional prompts to the digital twin 104. For example, block 308 may send text prompts that ask questions about the hardware configuration, such as, “How many processors do you have?” If any question returns an inaccurate answer, block 308 may repeat the hardware prompt to cause the digital twin 104 to correct its configuration. When these questions all return accurate answers, then validation 308 is complete.

This process may be repeated, returning to blocks 302 and 304 to repeat the connection and the retrieval of hardware information. The repetition may be periodic, for example according to a schedule or the expiration of a predetermined time period, or may be performed responsive to a triggering condition, such as the detection of a change in operational status of the original system 102. If the retrieved hardware information has not changed, then no further action needs to be performed until the next repetition. If the retrieved information has changed, then block 306 generates new hardware prompts and block 308 validates the new hardware configuration. In this manner, the digital twin 104 may be kept up-to-date through changes to the hardware configuration of the original system 102. Each of the various blocks shown in FIG. 3 that are part of the virtual hardware generator 202 are, in at least some embodiments, performed in an automated manner via the code 819 shown in FIG. 8.

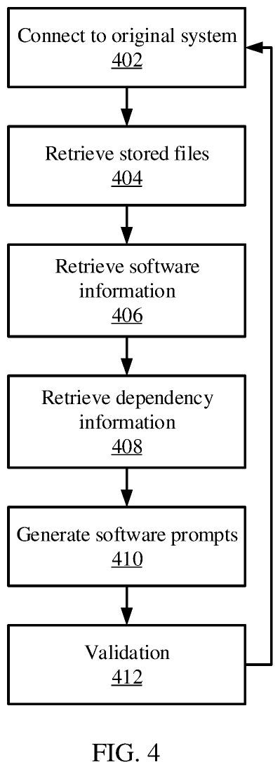

Referring now to FIG. 4, detail on the operation of the software circumstances generator 204 is shown. As with the virtual hardware generator 202, the software circumstances generator 204 establishes a connection to the original system 102 in block 402. The software circumstances generator 204 may use the same connection as the virtual hardware generator 202 or may establish a separate connection as needed.

Block 404 retrieves files stored on the original system 102. For example, all of the files of the original system 102 may be scanned and copied to replicate these files in the digital twin 104. The files may be stored in a file system that is accessible to the language model, or they may be entered into the language model's memory directly.

Block 406 retrieves software information from the original system 102. This software information may include information relating to the operating system, such as type and version number, as well as information relating to applications running on the original system 102, including package name, version number, and configuration information.

Block 408 further retrieves dependency information. While this dependency information may describe relationships between software packages hosted on the original system 102, it may also include indications of off-system resources. For example, if the original system 102 makes references to a database that is stored on a separate computer system, then this dependency may be identified and may be provided to the digital twin 104 as a prompt.

Block 410 generates software prompts relating to the stored files, the software information, and the dependency information and submits these prompts to the digital twin 104. As with the hardware prompts, the software prompts may be natural language instructions that tell the large language model of the digital twin 104 how to imitate the software of the original system 102. Block 412 may then perform validation of the digital twin 104 by sending natural language questions that confirm the software configuration of the digital twin 104.

As with the hardware configuration of the digital twin 104, the software configuration may be kept up-to-date by repeating the retrieval of information from the original system 102 and making any needed changes by additional prompts to the digital twin 104. The language model underlying the digital twin may be trained on a body of text that includes information about software packages, so that the software configuration information can invoke the correct understanding of the original system 102. Each of the various blocks shown in FIG. 4 that are part of the software circumstances generator 202 are, in at least some embodiments, performed in an automated manner via the code 819 shown in FIG. 8.

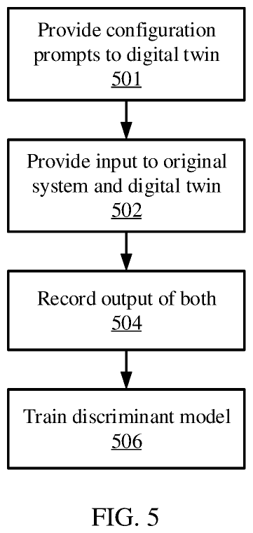

Referring now to FIG. 5, part of the operation of the action feedback simulator 206 is shown. Block 501 provides the hardware and software prompts to the language model of the digital twin 104 as described above. The hardware and software prompts include those produced in the operations illustrated in FIGS. 3 and 4. This provision to the language model configures the initial state of the digital twin 104 and may include any appropriate amount of validation to ensure that the digital twin 104 is a correct representation of the software and hardware configurations of the original system 102.

Block 502 provides inputs to both the original system 102 and the digital twin 104 and block 504 records the output of both. The outputs are used in block 506 to train a discriminant model to identify whether a given output is generated by the original system 102 or by the digital twin 104. In at least some embodiments, the discriminant model is implemented as a neural network classifier that outputs a probability score to indicate whether the output was generated by one system or the other. The discriminant model is a type of machine learning model. Each of the various blocks shown in FIG. 5 that are part of the action feedback simulator 206 are, in at least some embodiments, performed in an automated manner via the code 819 shown in FIG. 8.

This training process may be performed over an extended period of time, using actual operation of the original system 102 to train the digital twin 104 in parallel. In alternative embodiments, a set of inputs and outputs for the original system 102 is recorded in advance as a training dataset, and these events are used for training of the digital twin 104 and the discriminant model in an offline fashion.

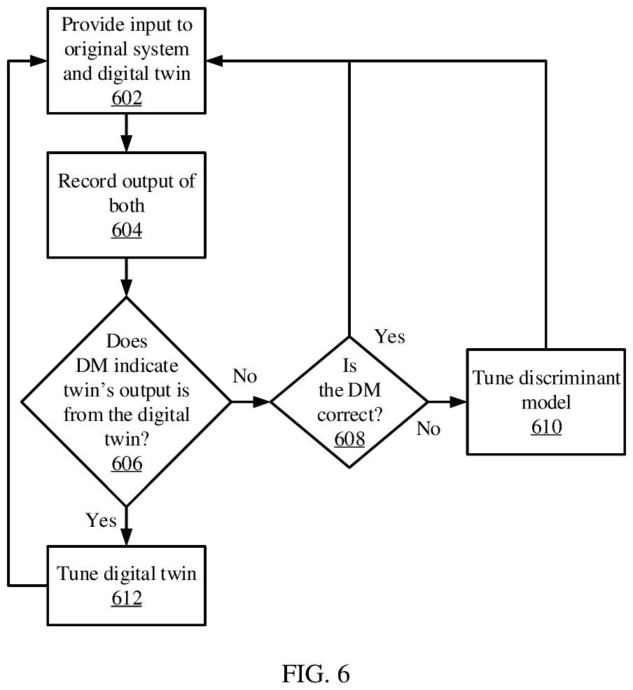

Referring now to FIG. 6, additional operation of the action feedback simulator 206 is shown. After an initial discriminator model has been trained, online fine-tuning of the large language model hosting the digital twin 104 and further refinement of the discriminant model are performed in tandem in some embodiments. Block 602 provides an input to the original system 102 and to the digital twin 104 and block 604 records the outputs of both. Using the trained discriminant model, block 606 makes a determination of whether the digital twin's output came from digital twin 104. If so, then block 612 uses the outputs of the original system 102 and the digital twin to fine-tune the digital twin 104 and processing returns to block 602 for the next input.

If in block 606 the discriminant model makes a determination that the digital twin's output did not come from the digital twin, then the processing proceeds to block 608. Block 608 makes a determination of whether the conclusion of the discriminant model was correct. Although the discriminant model is not initially provided the correct answer, the action feedback simulator 206 knows the correct answer for the determination of block 608 because the action feedback simulator 206 knows whether the analyzed output was from the digital twin or not. If the discriminant model incorrectly indicates that the digital twin's output is not from the digital twin 104, then that information is used in block 610 to tune the discriminant model. In particular, weights of the discriminant model may be adjusted to improve the ability of the discriminant model to correctly identify the output of the digital twin 104. If the discriminant model correctly indicated that the provided sample was not in fact from the digital twin 104, then the processing returns to step 602 for the next input. No updating to the discriminant model is necessary under that instance, because the discriminant model made a correct evaluation regarding the origin of the sample with which it was fed.

Thus, the discriminant model works with the language model in an adversarial manner to improve the training of the language model so that the digital twin 104 hosted by the language model better mimics the actual operating system 102. If the discriminant model successfully can recognize that output is from the digital twin 104 instead of from the original system 102, the digital twin 104 needs updates and receives those updates so that the digital twin 104 better mimics the actual original system 102. If the discriminant model incorrectly makes predictions about the origin of an output that it receives, then the discriminant model is updated to better be able to distinguish origin as occurring from the digital twin 104 or from the original system 102. These updates work in multiple iterations until both are improved and some balance is obtained in the predictive success of the discriminant model.

In some embodiments, the adversarial training with the discriminant model occurs by submitting multiple samples to the discriminant model. The samples include some outputs from the original system 102 and some outputs from the digital twin 104. In some embodiments, sample sets from both original system 102 and from digital twin 104 are submitted to the discriminant model in response to the original system 102 and the digital twin 104 receiving the same input. Using the same input creates a test set of digital twin output and original system output which should closely approximate each other if the digital twin 104 is mimicking the original system 102 successfully.

This processing continues with new inputs, further refining both the discriminant model and the digital twin 104 itself. Thus there are multiple ways to update the digital twin 104 as the operating conditions of the original system 102 change, which can be run concurrently. The digital twin 104 may be updated by changing its prompts relating to the hardware information and the software information, and the digital twin 104 may be updated by identifying outputs that differ from those of the original system 102. During operation, the digital twin 104 may be used in circumstances where the original system and its physical equipment are particularly expensive or fragile. The digital twin 104 may be used in such instances to help develop and test procedures that would otherwise be inconvenient, difficult, or expensive to perform on the original system itself 102.

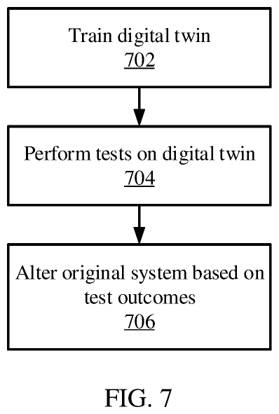

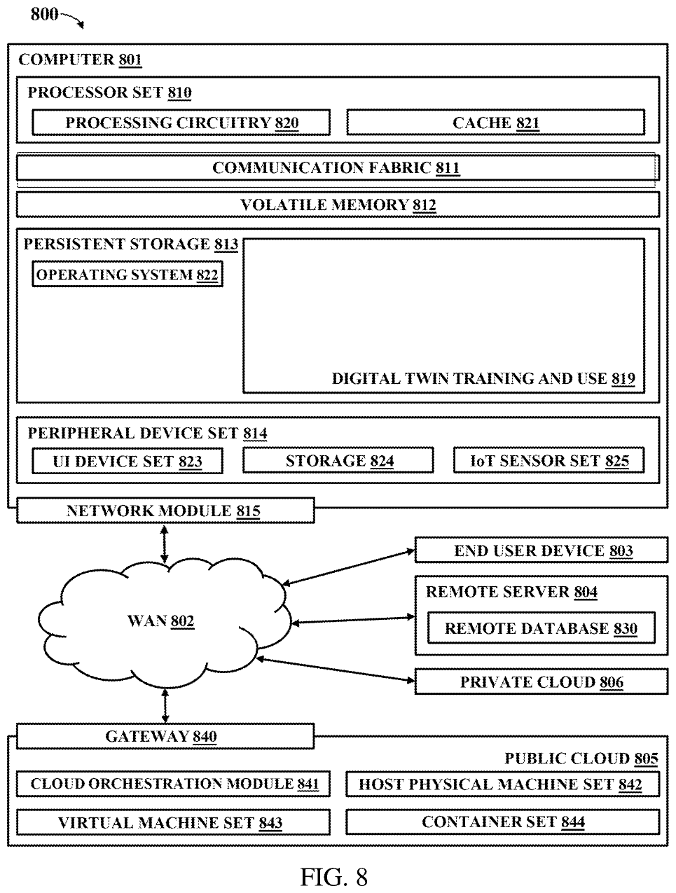

Referring now to FIG. 7, a method of making and using a digital twin is shown. Block 702 trains the digital twin 104, as described above, using symbiotic training to help an underlying language model learn how to imitate the original system 102. After the digital twin 104 has been created, the digital twin 104 is tested by block 704 according to any appropriate testing process. Because the digital twin 104 may be implemented as software, with arbitrary resources being dedicated to its execution, testing may be performed more efficiently than if testing were performed on the original system 102.

Based on the outcome of the testing, block 706 may make an alteration to the operation or design of the original system 102. For example, if testing on the digital twin 104 reveals a potential defect or future breakdown of the original system 102, then block 706 provides for replacement or repair. In such scenario block 706 includes the generation and display of warnings that indicate the predicted defect and/or breakdown and in some circumstances a predicted date and time for the emergence of the predicted defect and/or breakdown. In some instances, block 706 includes automated steps for replacement and/or repair such as the code 819 automatically ordering replacement parts and/or software updates. For software updates that are able to be performed in an automated manner, block 706 incorporates the automatic version update and/or new software installation for repair in various embodiments. If testing reveals a bug that would provide poor performance or unexpected behavior, then block 706 may patch the software of the original system 102.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring now to FIG. 8, a block diagram of a computing environment is shown. Computing environment 800 contains an example of an environment for the execution of at least some of the computer code involved in performing the inventive methods, such as digital twin training and use 819. In addition to block 819, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 819, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible.

Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 819 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 819 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices.

Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

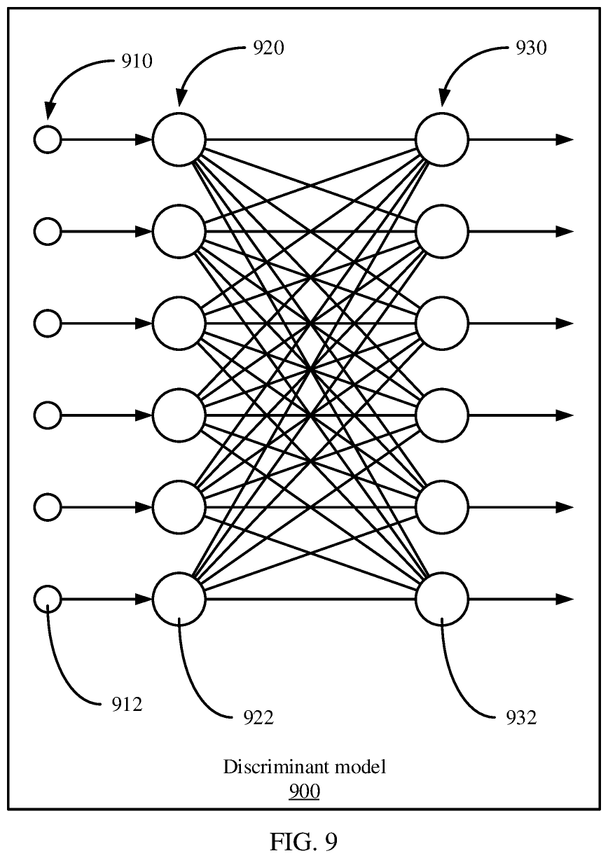

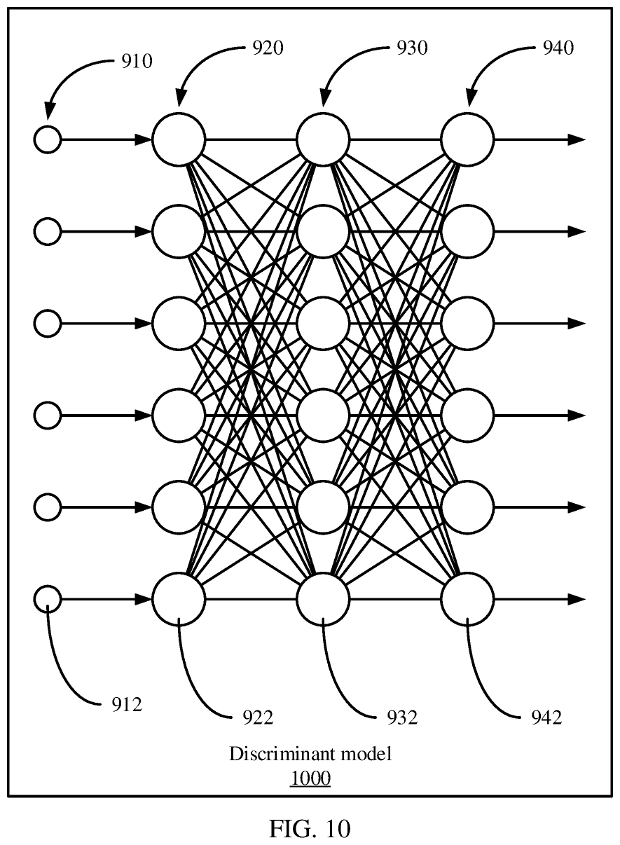

Referring now to FIGS. 9 and 10, exemplary neural network architectures are shown, which may be used to implement parts of the present models, such as discriminant models 900/1000. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 920 of source nodes 922, and a single computation layer 930 having one or more computation nodes 932 that also act as output nodes, where there is a single computation node 932 for each possible category into which the input example could be classified. An input layer 920 can have a number of source nodes 922 equal to the number of data values 912 in the input data 910. The data values 912 in the input data 910 can be represented as a column vector. Each computation node 932 in the computation layer 930 generates a linear combination of weighted values from the input data 910 fed into input nodes 920, and applies a non-linear activation function that is differentiable to the sum. The exemplary simple neural network can perform classification on linearly separable examples (e.g., patterns).

A deep neural network, such as a multilayer perceptron, can have an input layer 920 of source nodes 922, one or more computation layer(s) 930 having one or more computation nodes 932, and an output layer 940, where there is a single output node 942 for each possible category into which the input example could be classified. An input layer 920 can have a number of source nodes 922 equal to the number of data values 912 in the input data 910. The computation nodes 932 in the computation layer(s) 930 can also be referred to as hidden layers, because they are between the source nodes 922 and output node(s) 942 and are not directly observed. Each node 932, 942 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Having described preferred embodiments of digital twin symbiotic training (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method of training a digital twin, comprising:
submitting a hardware prompt to a language machine learning model, the hardware prompt characterizing hardware of an original system;
submitting a software prompt to the language machine learning model, the software prompt characterizing software of the original system;
training a discriminant machine learning model to distinguish between outputs of the original system and outputs of the language machine learning model; and
tuning the language machine learning model to act as a digital twin of the original system based on an output of the discriminant machine learning model, an output of the language machine learning model, and an output of the original system.

2. The method of claim 1, further comprising validating a hardware configuration, generated via the submitting of the hardware prompt to the language machine learning model, by prompting the language machine learning model to describe the hardware configuration and comparing an output description to the hardware of the original system.

3. The method of claim 1, wherein the software prompt includes a description of software on the original system and dependencies for the software.

4. The method of claim 3, further comprising validating a software configuration, generated via the submitting of the software prompt to the language machine learning model, by prompting the language machine learning model to describe the software configuration and comparing an output description to the software and dependencies of the original system.

5. The method of claim 1, wherein the discriminant machine learning model is a neural network classifier that accepts a system output and that generates a classification as to whether the system output was generated by the digital twin.

6. The method of claim 5, further comprising tuning the discriminant machine learning model responsive to a determination that the discriminant machine learning model has incorrectly identified output from the digital twin as being output from the original system.

7. The method of claim 1, wherein tuning the language machine learning model is performed responsive to a determination that the discriminant machine learning model has correctly identified output from the digital twin.

8. The method of claim 1, further comprising testing the digital twin independently from inputs to the original system.

9. The method of claim 8, further comprising altering the original system responsive to the testing.

10. The method of claim 1, wherein the output of the language machine learning model and the output of the original system are generated responsive to a single input.

11. A computer program product for training a digital twin, the computer program product comprising a computer readable storage medium having program instructions embodied therewith, the program instructions being executable by a hardware processor to cause the hardware processor to:
submit a hardware prompt to a language machine learning model, the hardware prompt characterizing hardware of an original system;
submit a software prompt to the language machine learning model, the software prompt characterizing software of the original system;
train a discriminant machine learning model to distinguish between outputs of the original system and outputs of the language machine learning model; and
tune the language machine learning model to act as a digital twin of the original system based on an output of the discriminant machine learning model, an output of the language machine learning model, and an output of the original system.

12. A system for training a digital twin, comprising:
a hardware processor; and
a memory that stores a computer program which, when executed by the hardware processor, causes the hardware processor to:
submit a hardware prompt to a language machine learning model, the hardware prompt characterizing hardware of an original system;
submit a software prompt to the language machine learning model, the software prompt characterizing software of the original system;
train a discriminant machine learning model to distinguish between outputs of the original system and outputs of the language machine learning model; and
tune the language machine learning model to act as a digital twin of the original system based on an output of the discriminant machine learning model, an output of the language machine learning model, and an output of the original system.

13. The system of claim 12, wherein the computer program further causes the hardware processor to validate a hardware configuration by prompting the language machine learning model to describe the hardware configuration and to compare an output description to the hardware of the original system.

14. The system of claim 12, the software prompt includes a description of software on the original system and dependencies for the software.

15. The system of claim 14, wherein the computer program further causes the hardware processor to validate a software configuration by prompting the language machine learning model to describe the software configuration and to compare an output description to the software and dependencies of the original system.

16. The system of claim 12, wherein the discriminant machine learning model is a neural network classifier that accepts a system output and that generates a classification as to whether the system output was generated by the digital twin.

17. The system of claim 16, wherein the computer program further causes the hardware processor to tune the discriminant machine learning model responsive to a determination that the discriminant machine learning model has incorrectly identified output from the digital twin as being output from the original system.

18. The system of claim 12, wherein the computer program further causes the hardware processor to tune the language machine learning model responsive to a determination that the discriminant machine learning model has correctly identified output from the digital twin.

19. The system of claim 12, wherein the computer program further causes the hardware processor to test the digital twin independently from inputs to the original system.

20. The system of claim 19, wherein the computer program further causes the hardware processor to alter the original system responsive to the testing.
